(19) United States
(12) Patent Application Publication
(10) Pub. No.: US 2017/0011319 A1
(43) Pub. Date: Jan. 12, 2017

(54) SYSTEM OF REAL-TIME MULTI FACTOR QUEUE MANAGEMENT

(71) Applicant: QUEUEFX TECHNOLOGIES PTY LTD, Deakin Act (AU)

(72) Inventors: David ELLIOT, Yarralumla ACT (AU); Priya DEV, Yarralumla ACT (AU)

(73) Assignee: QUEUEFX TECHNOLOGIES PTY LTD, Deakin Act (AU)

(21) Appl. No.: 15/117,743

(22) PCT Filed: Feb. 11, 2015
(86) PCT No.: PCT/AU2015/000077

§ 371 Date: Aug. 10, 2016

(30) Foreign Application Priority Data
Feb. 11, 2014 (AU) 2014900402

(51) Int. Cl. G06Q 10/06; G06Q 50/12; G06Q 10/08

(52) U.S. Cl. CPC G06Q 10/06313; G06Q 10/083; G06Q 50/12

(57) ABSTRACT

A method for managing parameters associated with a product or service order by a user and its subsequent delivery to the user; the method comprising inputting order data into a digital device thereby to define an order; transmitting the order to a queue management server; receiving historical data associated with the order; receiving substantially real time data associated with the order thereby to define an estimated pickup/delivery time coinciding with the estimated order fulfilment time. Also disclosed is a system for implementing the method. Also disclosed is a local queue management processor or engine.

### TECHNICAL FIELD

The present invention relates to a system of real time multi factor queue management and related methodology. More particularly, but not exclusively, it relates to apparatus and systems and methods for pre-emptively managing the creation of orders for goods and services and also pre-emptively managing resources for the fulfilment of the orders. Even more particularly, embodiments of the invention relate to queuing and data processing data structures and algorithms for seeking to minimise the formation of queues in the context of manufacturing resources again particularly, but not necessarily exclusively, in the environment of supply of foods and more particularly, fast foods.

### BACKGROUND

Queues are a major inconvenience and the source of significant inefficiency in most business endeavours. The nature of human interactions, the preparation and supply of goods and services and the payment for these items involves a complex interaction of factors.

There is much literature relating broadly to management of queues in many contexts. In a data processing context, there exists U.S. Pat. No. 8,320,247 to Juniper Networks, Inc. which describes dynamic queue management in the context of network routers.

Particularly in relation to management of ordering and delivery of fast food at least the following art is of record:

US 20080052173 A1

ABSTRACT

The fast food wrapping and delivery method and system use an ink jet printer that can print patterns in either obverse form and reverse form to print a food order and nutrition information of a food on a food container in real-time. When a POS system receives the food order from a customer, the POS system controls the ink jet printer to print the food order (or plus some additional instructions for making a food and nutrition information of the food) on one side of the food container to generate a custom fabricated food container that best fits with each unique food product ordered by a customer,

US 20020124257 A1

ABSTRACT

Order-delivery service via interactive systems (TV set with cable box or satellite dish network, Wireless or Pro(Wireless, PDAs, handhelds, pocket PCs) providing customers with access to menus of fast food restaurants, other restaurants and dining places and ability to order and receive a fast delivery using a remote control device for a TV set, cable box, or satellite dish network box.

US 20060218039 A1

ABSTRACT

A fast food restaurant and method of operating a fast food restaurant, the restaurant having an order and staging station for drive through customers. The order and staging station has a plurality of order stalls for customer vehicles, each order stall having an order panel with a menu display and a touch screen or voice or speech activator for self-service menu item selection and order placement. The order panel also has a payment acceptor and an order status reporter. The customer vehicle remains in the order stall until the customer is notified that the order is ready for pickup at a delivery station.

U.S. Pat. No. 5,287,948 A

ABSTRACT

A food service facility for drive-up and walk-up patronage, a multi-purpose column, conveyor delivery structures, and menu and order display units. The food service facility comprises base level and second level housings, readily set up and removed from a site.

WO 2001020444 A1

ABSTRACT

A food order is placed from a location remote from a food preparation premise (24). A transponder (18) identifiable by a transponder identifier is detected about at the food preparation premise (24). The food order is identified based on the transponder identifier.

A fast food chain has proposed use of an in-restaurant kiosk which customers may use to place fast food orders. In response to receiving an order from the in-restaurant kiosk, food items in the order are prepared and/or gathered. Thereafter, the completed food items are given to a customer who placed the order. Although many individuals enjoy the convenience of ordering prepared food from restaurants, a few shortcomings exist. One shortcoming is having to wait, after placing an order at a restaurant, for the food to be prepared. This shortcoming typically contributes to lengthened lines at fast food counters and drive-through windows, and lengthened lines for seating at dine-in restaurants. To mitigate this shortcoming, a restaurant may prepare some food items prior to being ordered. This approach, however, is disadvantageous in that food items may stand (e.g. under a heat lamp) for an undesirable time duration before being ordered.

All of these “fast food” related publications tend to relate to quite specific and narrow tasks associated with the ordering, production and delivery of fast food.

As will be observed further in the specification embodiments of the present application address a far more “holistic” problem which includes taking into account multiple factors from multiple locations. The factors take the form of data pertinent to historical behaviour of the customer and the production systems and also take the form of data pertinent to real time measurements affecting time of production and/or desired time of pick up.

Production lines are successful because of the predictability of the components and steps involved in the process. However, such systems do not support the highly unpredictable and highly variable factors involved with human activity and decision making.

For example providing food for many people in a highly efficient flow is a very complex process. Each customer may require a different food order, which takes a different length of time and complexity to prepare. The temperature of cooked food limits the window in which food can be delivered and the order in which customers place orders can add complex elements such as order congestion and overload of resources.

Typically such situations are handled as best possible by a very experienced manager or operator, however the reality of the hundreds and often thousands of interacting priorities and procedures inevitably leads to inefficiencies, frustration of customer and supplier, and in most cases, an inefficient queue.

The described invention is designed to address these issues.

Embodiments of the invention seek to minimise, if not, entirely eliminate queues or at least the need to wait at a physical point of service for delivery of a good or service.

### Brief Description of Invention

Broadly, embodiments of the invention seek to orchestrate one or both of the creation of orders for use of production resources and the utilisation of those production resources. In particular forms, the orchestration is conducted in a pre-emptive manner. Also, in particular forms, significant data input is accepted thereby to take into account many factors including real time factors that affect the orchestration.

Accordingly in one broad form of the invention there is provided a method for managing parameters associated with a product or service order by a user and its subsequent delivery to the user;
said method comprising
inputting order data into a digital device thereby to define an order;
transmitting the order to a queue management server;
receiving historical data associated with the order;
receiving substantially real time data associated with the order thereby to define an estimated pickup/delivery time coinciding with the estimated order fulfilment time.

Preferably the real time data is data associated with the user.

Preferably the real time data relates to the activities and characteristics of the production environment in which the order is fulfilled

Preferably the real time data relates to the activities and characteristics of the general area in which the production environment is located.

Preferably the real time data comprises one or more of congestion data, current production time, location data

Preferably the historical data relates to activities and characteristics of the user.

Preferably the historical data relates to the activities and characteristics of the production environment in which the order is fulfilled

Preferably the historical data relates to the activities and characteristics of the general area in which the production environment is located.

Preferably the above method includes the further step of adjusting the production time to better match the estimated pickup time

Preferably the above method includes the further step of continuously recalculating an estimate of production time and reporting it on a substantially real-time basis to the user.

Preferably the above method includes the further step of accepting update data from the user as to preferred pickup time by the user and utilising the update data to adjust the order fulfilment process.

Preferably the above method includes the further step of accepting update data from the user's device as to location and velocity.

Preferably real-time data flow between the user and the server is bidirectional

Preferably information flow between the user and the server is bidirectional

Preferably local production equipment is integrated with a local management processor.

Preferably local production equipment is integrated with and/or interacts with a remote management processor communicating over the Internet.

Preferably the local management processor receives data from the local production equipment and surrounds.

Preferably the data received by the local management processor is processed by an analytic algorithm in order to deduce production information and queue information which is then on-transmitted to a remote server forming part of a queue management system.

In yet a further broad form of the invention there is provided a method of pre-emptively initiating, tracking and reporting travel of a consumer to a pick up location thereby to match time of arrival at the pick up location by the user with time of completion of production of an article; said method including pre-emptively managing production of the article.

In yet a further broad form of the invention there is provided a queue management engine comprising a processor in communication with at least a first memory; said processor including input/output facilities which communicate with sensing devices located within a production facility associated with and local to the queue management engine; said memory including code which when executed by the processor implements analysis of data received from the sensing devices; results of the analysis being on transmitted to a server located remote from the production facility.

Preferably at least one of the sensors is a video camera which feeds data to the processor for analysis by analytics software in order to deduce actions such as queue length, number of people in queue, rate of output of production facility.

Preferably at least one of the sensors is a sensor that detects when an order has been completed so that order completion time is sent to the server.

Preferably at least one of the sensors is a sensor that lambently detects when an order has been completed so that order completion time is sent to the server.

In yet a further broad form of the invention there is provided a system for managing parameters associated with a product or service order by a user and its subsequent delivery to the user;
said system comprising
a digital device which receives order data thereby to define an order;
a queue management server which receives data corresponding to the order;
the queue management server further receiving historical data associated with the order;
the queue management server further receiving substantially real time data associated with the order thereby to define an estimated pickup/delivery time coinciding with the estimated order fulfilment time.

Preferably the real time data is data associated with the user.

Preferably the real time data relates to the activities and characteristics of the production environment in which the order is fulfilled

Preferably the real time data relates to the activities and characteristics of the general area in which the production environment is located.

Preferably the real time data comprises one or more of congestion data, current production time, location data

Preferably the historical data relates to activities and characteristics of the user.

Preferably the historical data relates to the activities and characteristics of the production environment in which the order is fulfilled

Preferably the historical data relates to the activities and characteristics of the general area in which the production environment is located.

Preferably the system includes means for adjusting the production time to better match the estimated pickup time.

Preferably the system includes means for continuously recalculating an estimate of production time and reporting it on a substantially real-time basis to the user.

Preferably the system includes means for accepting update data from the user as to preferred pickup time by the user and utilising the update data to adjust the order fulfilment process.

Preferably real-time data flow between the user and the server is bidirectional

Preferably information flow between the user and the server is bidirectional

Preferably local production equipment is integrated with a local management processor.

Preferably the local management processor received data from the local production equipment and surrounds.

Preferably the data received by the local management processor is processed by an analytic algorithm in order to deduce production information and queue information that is then on-transmitted to a remote server forming part of a queue management system.

In yet a further broad form of the invention there is provided a system of pre-emptively initiating, tracking and reporting travel of a consumer to a pick up location thereby to match time of arrival at the pick up location by the user with time of completion of production of an article; said system including means for pre-emptively managing production of the article.

Preferably the system includes means for tracking and reporting travel which includes GPS or equivalent location monitoring thereby to track in three dimensional space relative to a geographic location and make estimates of travel speed and arrival time at a specified location therefrom.

### DRAWINGS

Embodiments of the present invention will now be described with reference to the accompanying drawings wherein:

FIG. 1 is a block diagram of the main components of an example embodiment

FIG. 2 is a block diagram of key components of an embodiment of the Queue Management System

FIG. 3 is a block diagram o Control Process of the Example Embodiment

FIG. 4 is a flow chart of a system in accordance with a further embodiment of the invention.

FIG. 5 is a block diagram of components and a network structure suitable to give effect to an implementation of the system of FIG. 4.

FIG. 6 is a diagram of messaging communication and associated graphs relating to orchestration of delivery of a good or service in accordance with an embodiment of the invention.

### DESCRIPTION AND OPERATION

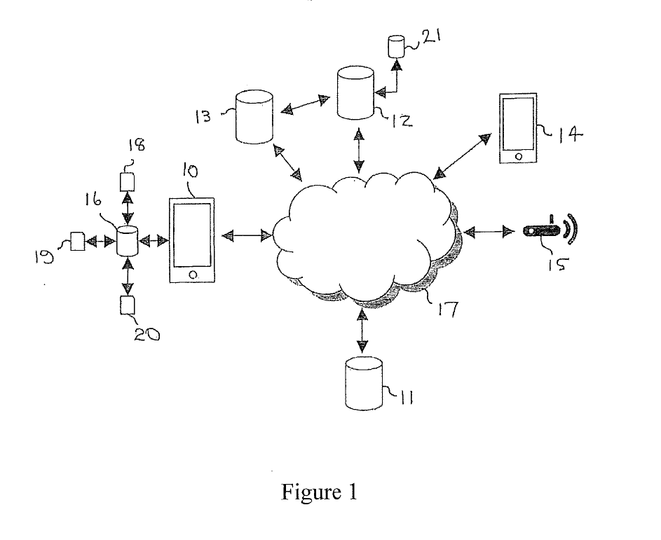

FIG. 1 discloses the main components of the example embodiment. A user uses a smart device 10, 14 such as a smart phone to connect to a queue management server 11 with the intent of receiving smart estimates of when an order they have placed for an item such as food has been placed. The order for food would typically be made using the smart device 10 and a network such as the Internet 17 to an order system 12 that initiates the provision of the requested item or items.

The users smart device 10 would typically include a client application 16 that allows the user to interact with the queue management server 11. That application 16 would also have access to customer details 18, customer location 19 such as GPS coordinates or Wifi location triangulation and details about the users order 20.

The queue management server uses information from the users smart device 10 and application 16 to coordinate the efficient and convenient delivery of an order by the customer 10 from a service or product supplier such as a food vendor at an event such as a stadium football game.

Typically an online order system 12 is partnered with an order fulfilment system 13 to manage the process of producing and delivering an order to the customer who purchased the item.

It is also typical that an order system would have historical data 21 and metrics about each item and type of order the system has produced in the past. This information may be used as part of the order delivery time frame estimate along with real time sensor information 15 coming from equipment and monitors in and around the supplier's equipment.

Other sensors of the type such as real time sensor 15 in and around the location of the supplier and the user may help produce information that is valuable in accurately estimating and adjusting delivery queues of products or items being supplied to customers.

Sensors 15 may also be used for applications not directly related to the operations of a product or service supplier. For example sensors 15 may be used to monitor human traffic congestion in locations that may have a bearing on item delivery queuing. Actual queue length of people standing in line to received purchased items may also be monitored.

Sensors may include and not be limited to video cameras, heat and weight sensors as well as mechanical sensors such as door position and wireless network congestion.

Such a system can enable as much data as possible to be provided to the queue management system so that it can make the most accurate, convenient and efficient queuing order for the delivery of items to customers.

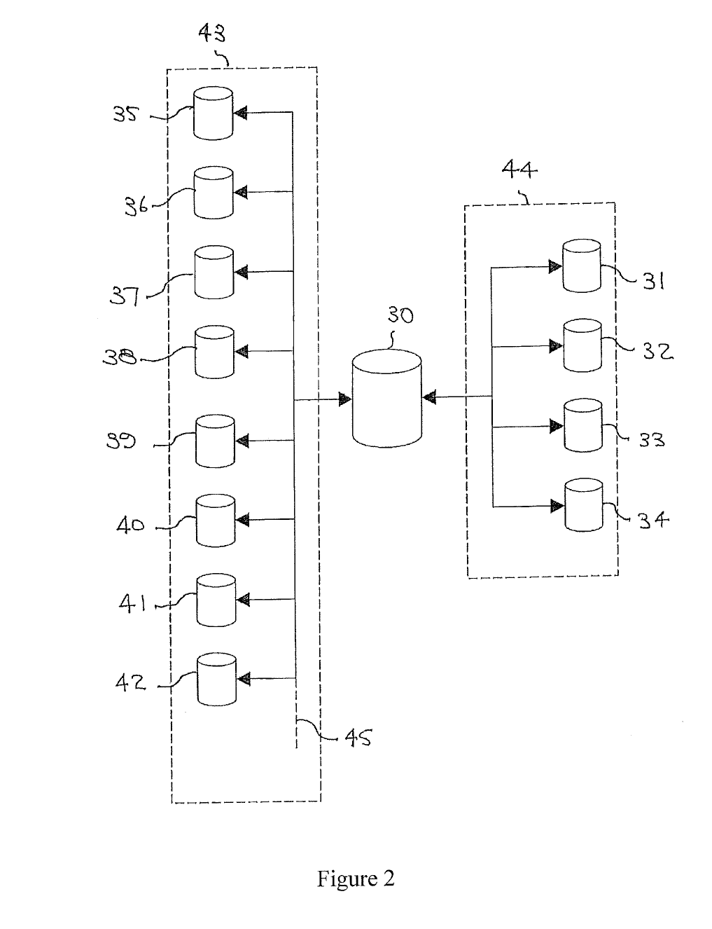

FIG. 2 discloses the key components of the queue management server system. A central control management application 30 obtains input data from multiple sources 43 and interacts with various external systems 44 to deliver optimised queuing of customer orders.

Sources of valuable data for the system include but are not limited to the order item information and timestamp 35 detailing when the order was initially placed by the customer and the components that make up the order. An order item preparation time estimate 36 can be obtained from the historical data of the suppliers order system or data shared from other systems that produce the same items.

Additionally real time order preparation progress feedback is monitored 37. The client application used by the customer may also be used to prompt the user to give feedback to help in the queuing system. For example if the user has to attend to an important phone call, the user may request a short delay on the delivery time of their order.

Real time customer location 39 can be used to estimate the walking or travel time from the users current location to the pickup point of the order.

Real time information about other user activity in the queue with the current user can be used to tune delivery to avoid congestion at the product or service pickup location. Queue position slipping can also be monitored 40 to ensure that the queue is optimised for efficient, convenient and effective product or service delivery. Information about order completion and or pickup is also used as an input 41.

Additionally site related factors, both historical and real time 42 can be used in calculating efficient queue optimisation. For example the congestion before and after a football game can be factored based on real time sensor and historical data to accurately determine travel time from a person's location to a pickup point. Conversely mid game low congestion can be optimised in calculating ideal travel estimates for customers wanting to pick up their items.

Additional sensor or system data 45 can be added to the metrics used for calculating the optimal queue order for delivery of goods or services to customers.

Information about optimised queue positions of orders can be used to provide system status updates 31, to optimise order preparation 32, to request feedback from users 33 and to provide confirmations of critical information 34 to other parts of the network system including the customer themselves.

An example of where order preparation optimisation may be useful is where a customer is being held up trying to reach a delivery location for an order by congestion of people at the beginning of a football game. An order preparation optimisation system may use information from the queuing system to have a hot food order placed in a warmer to ensure it does not go cold during the delay being experienced by the customer.

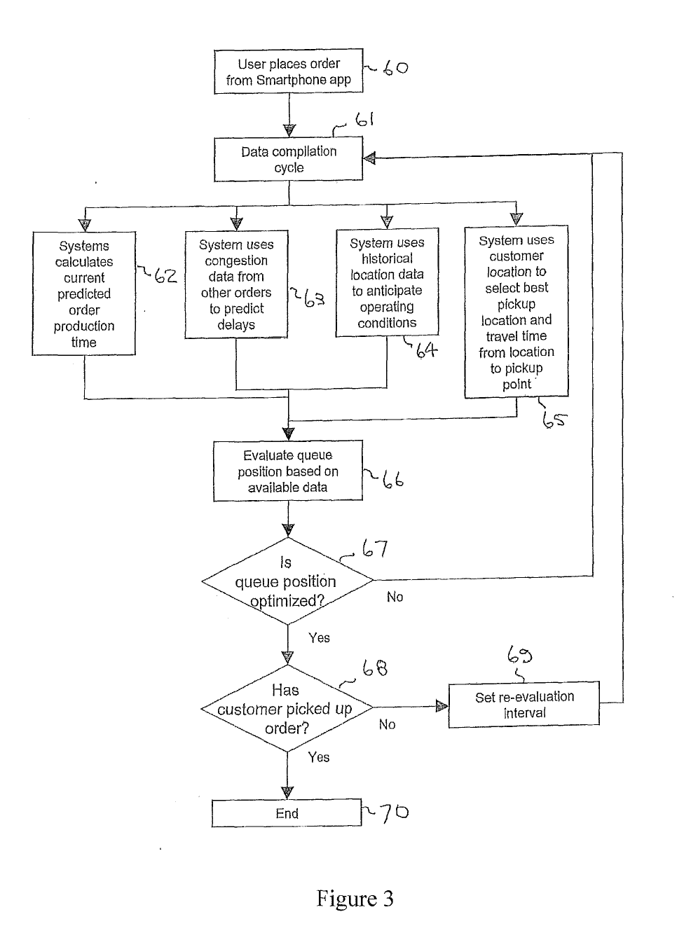

FIG. 3 shows the control process of the example embodiment. Initially the user places an order for a product or service using the application on theft smartphone 60. Then a compilation process starts 61 where data is collated and collected for processing.

The system then calculates simultaneously many factors to deliver an accurate optimised queue position. One calculation involves the estimation of the current order production time

62. This may involve historical data relating to the specific order type and also real time sensor information within the suppliers production system.

The system may also use information about other orders in the system 63 and how they may impact the production of the order due to things such as congestion delays. Another example of a factor that helps in accurately predicting a queue position is the historical data regarding.

the location around both the customer and the supplier 64. For example historical data at a football arena may estimate that a user will take eighty percent more time to get to a vendors pickup point during a halftime break in the game than if they were to pick up the order mid game.

Another example of data that may be used in estimating a queue position is information about the users current location and time estimates to travel to the nearest vendor pickup points 65. This step may require interaction with other inputs to be effective. For example if one vendor pickup point is experiencing delays, the next nearest vendor pickup location may be used to avoid queue delays for the customer.

Next the results of the input data 62 63 64 65 are evaluated and compared so that individual data results are assessed in combination across all the data sets. Next, the system evaluates the data to see if the combined data is within reasonable operational limits 67. The system then gives the order and customer a queue position and wait time.

If there are issues with the combined data that show undesirable results and a non optimised queue position 67, the data collection and calculation process 61 is repeated with a focus on the problem elements discovered during the previous cycle of data development.

If the system finds that the queue position for the customer and the order are optimised the system checks to see if the order has been picked up 68 and if not a request is placed to update the queue position after an interval of time to keep the queue position and status current 69. This is accomplished by re initiating the data compilation cycle 61.

If the order has been picked up the queue monitoring system completes its process 70.

### Alternative Embodiments

The example embodiment uses a case situation where food is being purchased, produced and delivered to customers at a football game. All the discussed sensors, systems and user related data are based on this particular application of the queuing management system.

An alternative embodiment may include any application where queues may develop or be produced. These may include but not be limited to supply of goods and services at events, at busy sales locations of any type or any situation or place where a queue is involved and timing of delivery is a factor in customer satisfaction, customer convenience and organisational operating efficiency and effectiveness.

FIG. 2 shows a large number of data feeds or collection points used by the central queue management system. An alternative embodiment may use a subset or extended set of data collection sources where two or more sources are used in calculating the optimum queue order. An alternative embodiment may also use one or more partnering data recipients that may use the data in their own production and or operational procedures.

The example embodiment discloses a situation where a customer is ordering food and picking it up from a vendor location. An alternative embodiment may include any system of delivering products or services to a customer including but not limited to in seat, or home delivery or any combination of full or partial service delivery.

The example embodiment shows a queue management system that gives feedback to a customer after they have purchased. An alternative embodiment may supply estimated or predicted queue and delivery time information to assist in the customer making a purchase decision.

Examples Hospitality Venues:

Large Venue Events

Customer places an order before they arrive at the event: Customer places an order for a combination of items. The system then detects that the customer is outside of the event location. When the customer is travelling to, close to or inside the event location the system is triggered to inject the order into the kitchen production line based on the customer's location and the kitchen's current and predicted production line capabilities (the kitchen is told which order to prepare next based on an optimisation of a number of data points including workflow, order contents, customer location, kitchen speed etc). The customer is then guided to a pickup point where the order will be ready as they arrive.

Customer places an order at the event: Customer places an order for a combination of items and wishes to pick them up or have them delivered at the fastest possible time. The system injects the order into the kitchen workflow and chooses a position in the workflow to optimise the timing of pickup or delivery from the customer's location to the concession stand to maximise the speed of kitchen fulfilment for all orders in current production and predicted production. Customer is given accurate wait estimates after placing the order and customer is able to track their position in the kitchen fulfilment queue, receiving updated wait time estimates. Customer is then alerted to pickup or receive delivery based on data points including their location and current kitchen fulfilment times and is also guided to the pickup point to ensure arrival at kitchen the scheduled fulfilment time.

Coffee Shops

As with large venues, orders may be placed within the venue or out of the venue. Orders may be injected into the system at the optimal time based on a number of data points including current kitchen fulfilment times and the customer's location. If the customer places the order outside the venue, the kitchen will not necessarily receive an immediate direction from the system to start preparing the order. It will be immediately injected into the kitchen fulfilment queue at an optimal position based on current data. Then based on updated information it will be injected to the kitchen display system when the customer is within a certain arrival time of the venue. The system will choose to inject the order into the kitchen display system to start preparing the order at the optimal time based on a set of data points.

Drive-Through

As with coffee shops, a customer may place the order from a remote location like their home or the office. In the drive-through food service environment the service times are usually short and customer demand is variable leading to either short order fulfilment times or delayed order fulfilment times. A customer's order will then be injected to the kitchen display for fulfilment at the optimal time based on the kitchen's current fulfilment time status and the customer's location. If for example the customer has not left their home, the order will not appear on the kitchen display system for fulfilment, instead it will be queued and injected into the system when the customer is on their way and within a certain time/distance of the drive through pickup area.

Takeaway Restaurants

These restaurants generally have longer order preparation times. This means order fulfilment times can be severely delayed if production is at capacity and orders are queued. A customer may wish to place an order for dinner at 3 pm for a 7 pm pickup. However, many other customers may also wish to place orders early on for a 7 pm pickup. Further, customers ordering at the venue (walk-up orders) before and around 7 pm will want orders to be fulfilled as soon as possible. This will result in delays in the kitchen for order fulfilment around 7 pm and not all customers will be able to pickup their orders at or around 7 pm. In this case the system will prompt customers as to when they should leave their current location so that they don't have to wait at the pickup point. The system will then inject orders to the kitchen display system at the optimal time for each customer to receive their orders as close as possible to their desired pickup time but optimised to maximise kitchen fulfilment speed. If the system later detects the customer is delayed and the order has not begun production, the order will be replaced by the most optimal order for kitchen production and customer pickup. Each customer will be able to track their fulfilment time and receive alerts to leave their current location to time customer arrival with fulfilment.

Examples Pre-Emptive Prompting:

An alternative embodiment uses a case situation in which valuable input data to the system includes customer motion (i.e., location and velocity) and ordering habits where both the customer and vendor are connected to the queue management server. In this situation historic ordering data is used by the system to infer that the customer regularly places a beverage order at a given time each morning from the vendor.

At a time relevant to the regular ordering habits of the customer the system detects that the customer is in motion toward or in the vicinity of the vendor. The control process is tracking valuable data inputs such as the current service time / production queue of the vendor and the motion of the customer. The system correlates this information to dispatch a prompt to the customer's smart device at an optimal time to invite the customer to place their regular order.

The customer optionally agrees to the pre-emptive prompting by the system (with payment either deferred or occurring automatically) at which point the system orchestrates order preparation at the vendor. The system concurrently guides the customer to the vendor pickup point according to the smart estimate of pickup time as continuously reported by the queue management server.

In an alternative embodiment the customer may simultaneously engage with pre-emptive order prompting from multiple vendors connected to the queue management server to execute multiple orders. In this example the customer may wish to pickup their beverage as soon as possible and only from vendors on chosen route to their ultimate destination. The system detects customer motion and time of day and suggests that the customer place a beverage order with vendor A based on their motion and vendor A's service time. Simultaneously the system suggests that the customer place a food order with vendor B based on their motion and vendor A's service time. At confirmation from the customer the system interacts with the vendor A and vendor B production systems such that the customer is able to pickup their beverage order from vendor A and food order from vendor B in a predictable manner.

In an alternative embodiment the customer may wish to place an order as soon as possible from vendor C which has a current scheduled pickup time of 28 minutes. Shortly thereafter the vendor C has a problem in the kitchen which the system detects via input data and computes that pickup will be delayed to 45 minutes. The system then pre-emptively prompts the customer to instead order from a vendor D which is also connected to the queue management server and now offers a faster alternative service based on the customer's motion. The customer agrees to the more convenient option at which point the system routes the order for production and pickup from vendor D.

Customer A is known to habitually order coffee around 8:40am every morning from vendor B. On any given morning the system detects when Customer A is travelling toward or nearby vendor B and concurrently knows the live service time / production line environment of vendor B. System sends a prompt to Customer A's digital device at optimal time based on live service time environment and Customer A's geographical distance from vendor B, asking if Customer A wishes to place their regular hot order. Customer A accepts (payment may or may not occur automatically) and system guides the customer to the service pickup where their hot order is just being made as customer arrives.

Customer A may authorise prompts from multiple vendors.

Customer A may authorise prompts from all vendors with optimal pickup time. In this example Customer A may wish to get their coffee as soon as possible and only from vendors on route or as close to their usual route to their office. The system then detects when Customer A is travelling based on their geographical location, movement and time of day and suggests that Customer A place order with vendor X based on their current location and vendor X's service time. Customer A will be told that vendor X will have Customer A's coffee ready in 5 minutes and that Customer A is currently only 5 minutes away.

Customer A may wish to place an order for as soon as possible at 6 pm from vendor C which has a current scheduled pickup time of 28 min. 5 min later Vendor C has a problem in the kitchen and scheduled pickup must be delayed to 45 min. Customer A may receive a prompt to order from Vendor D which will be faster based on their current geographical location and route to home.

### Pre-Emptive Embodiments

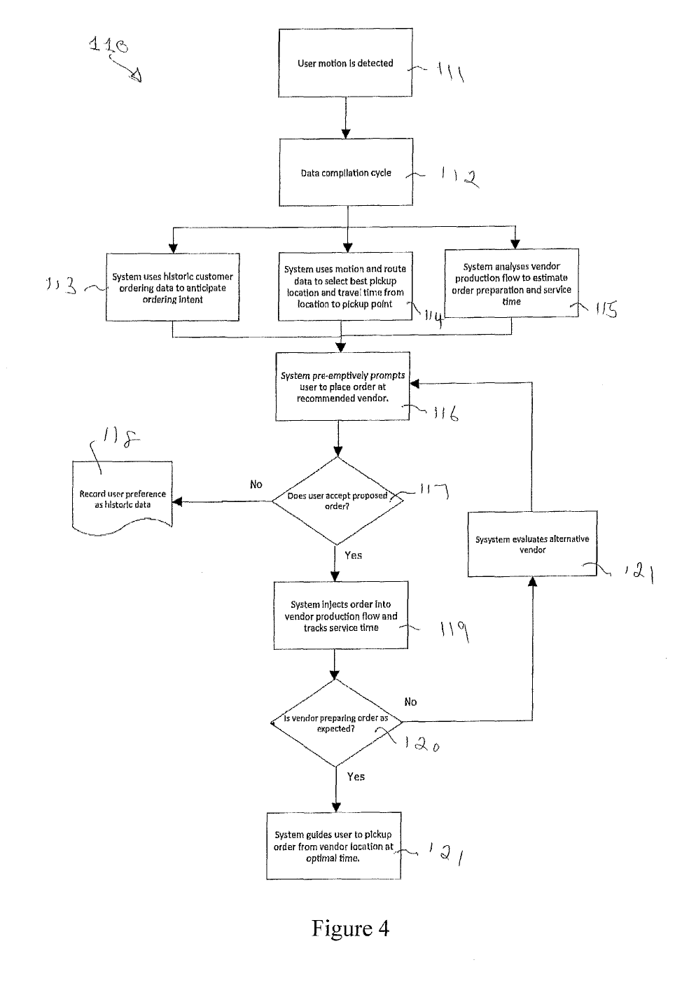

With reference to FIGS. 4 and 5 and 6, there is illustrated a flow chart and corresponding hardware block diagram and output diagram for a pre-emptive queue management system 110.

Initially, with reference to FIG. 4, in the event that user motion 111 is detected, then a data compilation cycle 112 commences whereby historic data at step 113 is taken into account together with user real time motion and route data at step 114 together with production flow data at step 115 thereby to pre-emptively prompt a user to place an order at step 116 typically and conveniently via a mobile digital device such as a Smartphone or the like.

At step 117, if it is determined that the user does not accept the pre-emptive prompt, then this rejection and related data is saved at step 118 to become part of the historic data for future reference. In the event the user accepts the promptive order, then the order is formally injected into the production flow at step 119 and the production process is monitored at 120. If data from the prospective order fulfilment vendor indicates that order fulfilment will not be optimal, the system can seek to instruct and alternative vendor at step 121.

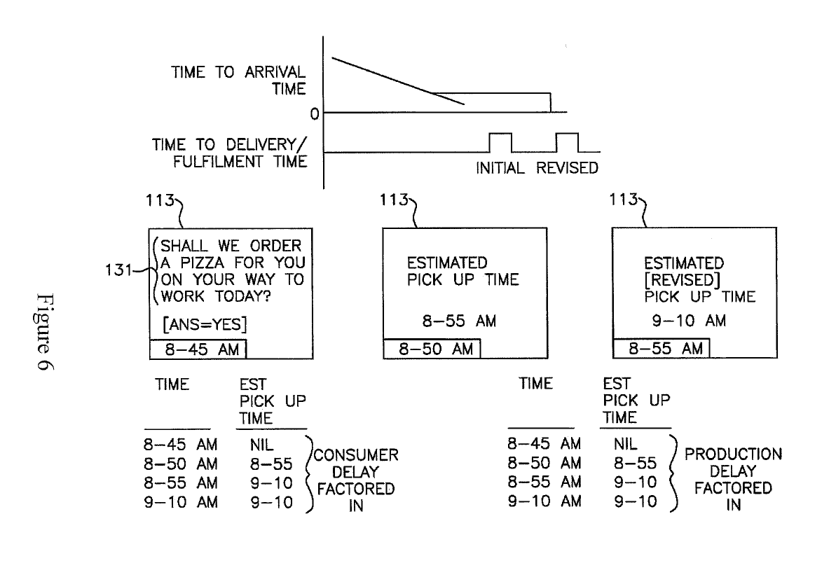

The system continues to monitor the selected vendor performance and proactively messages and guides the user at step 121 with a view to matching arrival time with the user at the point of delivery/order fulfilment with the actual time of order fulfilment. An example of visual guidance and a graph of system performance are provided in FIG. 6.

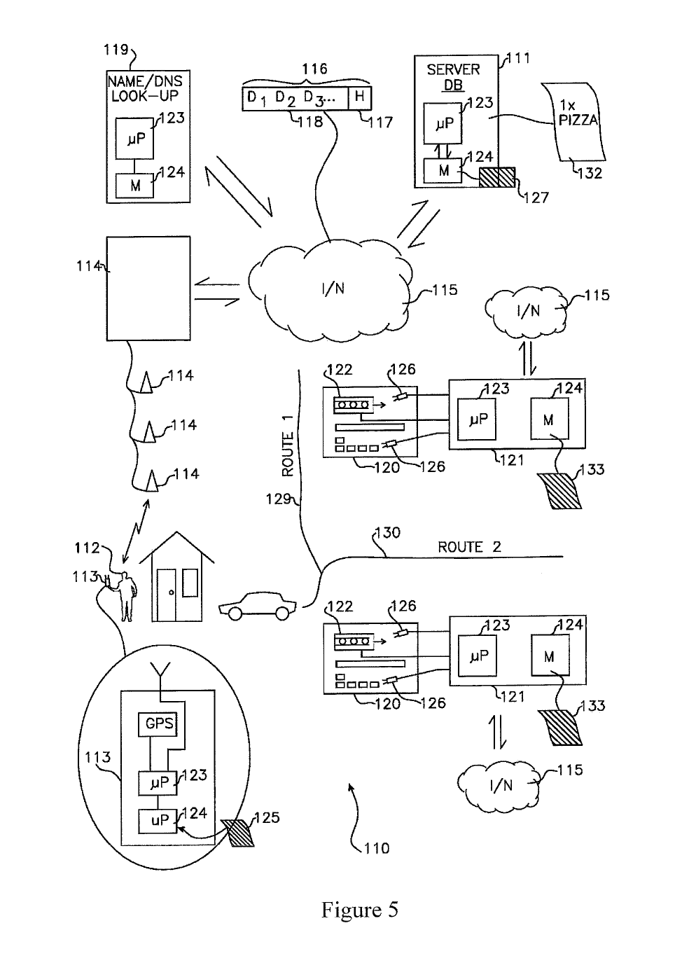

With reference to FIG. 5, detail of a particular form of hardware and associated hardware interaction for the pre-emptive queue management system 110 is illustrated. The core queue management algorithms and data storage structures reside on queue management server 111 wherein orders such as order 112 are received and processed.

A user 112 typically by way of a portable digital device 113 in the form of a Smartphone may generate the order 112 which is communicated in this instance via mobile telephone system 114 and network 115 to the server 111. In this instance, the network 115 comprise the Internet wherein data is transmitted by way of data packets 116, each data packet comprising a header portion 117 and a data portion 118. The header portion 117 includes address data corresponding to the Internet address of server 111. In preferred forms, the addressing is facilitated by name lookup servers 119 which act as a service to devices connected to the Internet 115.

The order 132 is transmitted via Internet 115 to an appropriate order fulfilment facility 120 in this instance in the form of a fast food outlet. The order fulfilment facility 120 will include a local queue management processor 121. The function of the queue management processor 121 is to receive the data comprising order 132 and to integrate that order into the local store production equipment 122. In addition, the local queue management processor 121 also termed a queue management engine in this specification performs the function of data acquisition from multiple sources within the local store and utilises this data on the one hand locally to assist in local management of the order within the order fulfilment facility and on the other hand to on-transmit the data via network 115 to queue management server 111 for the more global management of the order including the provision of status information to the portable digital device 113 of the user 112 and also for storage at the server 111 as historical data (refer earlier description as to nature and use of historical data).

The multiple sources of data can include various data acquisition devices as described in earlier embodiments, such devices allowing monitoring of the progress of an order fulfilment. In addition, the status of any existing queues can be monitored, preferably in real time. In one particular form, the data acquisition device can be in the form of a video camera 126 which feeds substantially real time video data to the local queue management processor 121 wherein ‘data analytic’ algorithms 133 are applied in order to intelligently interpret the scene at which the camera is directed thereby to substitute for multiple individual data acquisition devices. The analytics can distinguish human forms in a queue thereby to provide a count of people in a queue at the fulfilment facility. The analytics can also distinguish output from production equipment—for example where the output comprises pizzas the actual production rate of pizzas can be distinguished and indeed individual pizza composition can be associated with particular orders.

Each of the processing devices including portable digital device 113, local queue management processor 121 and server 111 include at least a digital router processor 123 and associated memory 124. Each memory stores program steps 125 for execution by the respective processor in order to give effect to the queue management activities of the queue management system 110. The same memories can store the analytic algorithms referred to above for local execution.

In particular forms, the entire process can be made ‘pre-emptive’ both in relation to the behaviour of the user 112 and also in relation to the behaviour of the local store production equipment 122. An example scenario will now be outlined with reference to FIG. 5 and FIG. 6.

In this particular embodiment, it may be early morning and a user 112 may be getting ready to leave for work. The server 111 may interrogate historical data 127 related to user 112. In addition, it may interrogate location data related to user 112 provided by GPS unit 128 located in portable digital device 113 in order to deduce that user 112 is at home and, statistically speaking, may be about to leave for a work location which, according, to historical data, may be arrived at by use of either a first route 129 or a second route 130. Again, the historical data may deduce that there is a high statistical likelihood that the user 112 would like to pick up a pizza on their way to their work location in the morning. Accordingly, at 8.45 am, a pre-emptive prompt message 131 (refer to FIG. 6) is sent to portable digital device 113 of user 112 to the effect ‘Shall we order a pizza for you on your way to work today?’ to which the user replies ‘yes’ thereby setting up an order 132 for fulfilment. The system 110 via GPS unit 128 monitors the initial passage of the user 112 to their workplace and determines that they have elected to travel via second route 130. The system 110 therefore transmits order 132 to the store closest to that route (designated “store 1” in FIG. 5), specifically to that store's local queue management processor 121. The system 110 monitors the initial progress of the user 112 along route 130 and determines initially that the user 112 will arrive at store 1 around 8:55 am and therefore schedules the order to be fulfilled at that time. In the course of monitoring, it becomes clear closer to 8:50 am that the user's progress is slower than usual based on GPS data received and therefore, the order is rescheduled for fulfilment at 9:10 am which time ultimately coincides with the arrival time of user 112 at store 1. In this manner, both the order itself is pre-emptively created and the production equipment 122 is pre-emptively managed via local queue management processor 121 and local store production equipment 122 in order to effect substantial coincidence of order pick up time with order fulfilment time.

Alternatively, or indeed, in addition, the system may note a delay in production whereby the scheduled fulfilment time of 8:55 am will not be achieved, and is replaced by a fulfilment time of 9.10 am. The revised time 9:10 am is communicated to the digital device of the user who can then elect to delay their journey so that they arrive at 9:10 am instead of 8.55 am.

Broadly, it will be observed that embodiments of the present invention allow orchestration of orders for delivery and orchestration of actual delivery with the goal of minimising formation of queues at the point of delivery. From one perspective, the system integrates with ‘back office’ systems so that it ‘knows’ current production capacity whereby the system can handle combinations of orders generated remotely and orders generated on site (in the context of fast food known as ‘walk ups’).

The above describes only some embodiments of the present invention and modifications may be made there too within the scope of the present invention.

1-38. (canceled)

39. A system for managing parameters associated with a product or service order by a user and its subsequent delivery to the user; said system comprising a digital device which receives order data thereby to define an order;
a queue management server which receives data corresponding to the order;
the queue management server further receiving historical data associated with the order;
the queue management server further receiving substantially real time data associated with the order thereby to define an estimated pickup/delivery time coinciding with the estimated order fulfilment time; and wherein local production equipment is integrated with a local management processor; and wherein the local management processor receives data from the local production equipment; and
wherein local production equipment is integrated with a local management processor; and wherein the local management processor receives data from the local production equipment; which data forms part of said real time data.

40. The system of claim 39 wherein the real time data is data associated with the user.

41. The system of claim 39 wherein the real time data relates to the activities and characteristics of the production environment in which the order is fulfilled.

42. The system of claim 39 wherein the real time data relates to the activities and characteristics of the general area in which the production environment is located.

43. The system of claim 39 wherein the real time data comprises one or more of congestion data, current production time, location data,

44. The system of claim 39 wherein the historical data relates to activities and characteristics of the user.

45. The system of claim 39 wherein the historical data relates to the activities and characteristics of the production environment in which the order is fulfilled.

46. The system of claim 39 wherein the historical data relates to the activities and characteristics of the general area in which the production environment is located,

47. The system of claim 39 including the further step of adjusting the production time to better match the estimated pickup time.

48. The system of claim 39 including the further step of continuously recalculating an estimate of production time and reporting it on a substantially real-time basis to the user.

49. The system of claim 39 including the further step of accepting update data from the user as to preferred pickup time by the user and utilising the update data to adjust the order fulfilment process.

50. The system of claim 39 wherein real-time data flow between the user and the server is bidirectional.

51. The system of claim 39 wherein information flow between the user and the server is bidirectional.

52. The system of claim 39 wherein the data received by the local management processor is processed by an analytic algorithm in order to deduce production information and queue information which is then on-transmitted to a remote server forming part of a queue management system.

53. The system of claim 39 wherein the digital device is a smartphone.

54. A system of pre-emptively initiating, tracking and reporting travel of a consumer to a pick up location thereby to match time of arrival at the pick up location by the user with time of completion of production of an article; said system including means for pre-emptively managing production of the article; and wherein local production equipment is integrated with a local management processor; and wherein the local management processor receives data from the local production equipment; which data forms part of real time data utilized by said system.

55. The system of claim 54 including means for tracking and reporting travel which includes GPS or equivalent location monitoring thereby to track in three dimensional space relative to a geographic location and make estimates of travel speed and arrival lime at a specified location therefrom.

56. A system for utilising a virtual queue to orchestrate the fulfilment of multiple concurrent orders for products or services by multiple customers; and for the subsequent order collection by, or delivery to, those customers;
said system comprising
capturing and consolidating new customer orders via digital input from multiple sources such as local point of sale and/or remote customer digital assistant;
qualifying incoming orders according to their burden of fulfilment and historical service time data to prioritise all active orders in a virtual tracking queue within a queue management server;
using the virtual tracking queue to undertake real time processing to accurately report on order position in fulfilment queue and estimated time of order fulfilment (completion);
updating each order within the virtual queue to push back or bring forward each order in the queue based on customer location data;
updating each order within the virtual queue to push back or bring forward each order in the queue based on data gathered from sensors in the fulfilment facility as may impact order fulfilment time;
application of algorithmic processing to the virtual queue to arrange orders in a sequence that will result in the fastest order processing in a manner that maximises overall order throughput;
measuring actual order fulfilment times including integrating local production equipment with local management processors and combining with historical fulfilment times based on order composition to continuously improve the predictive accuracy of the algorithmic processing of the virtual queue;
application of algorithmic processing to the virtual queue to issue pickup/delivery alerts to the customer based on theft geographical location and expected order fulfilment time to assist customers in receiving their order as soon as it is ready.
